(19) United States
(12) Patent Application Publication
(10) Pub. No.: US 2012/0282058 A1
(43) Pub. Date: Nov. 8, 2012

(54) Anchor Rod

(76) Inventor: Josef Glogger, Buchloe (DE)

(21) Appl. No.: 13/460,288

(22) Filed: Apr. 30, 2012

(30) Foreign Application Priority Data
Apr. 28, 2011 (DE) 102011017665.9

(51) Int. Cl. F16B 39/00

(52) U.S. Cl. 411/82

(57) ABSTRACT

An anchor rod for the chemical fastening in a bore hole has a bonding section comprising a fastening thread, which is provided for the embedding in the bore hole. The bonding section comprises at least one distortion lock with a clamping element embodied such that when the bonding section is embedded in the bore hole it develops a clamping effect in the longitudinal direction (A) of the bonding section when a force acts in the circumferential direction upon the fastening thread.

### CROSS-REFERENCE TO RELATED APPLICATIONS

The present application claims priority to German Patent Application DE 10 2011 017 665.9, filed Apr. 28, 2011, and entitled “Ankerstange” (“Anchor Rod”), which is hereby incorporated by reference in its entirety.

### BACKGROUND OF THE INVENTION

The present invention generally relates to an anchor rod for chemical fastening in a bore hole.

Anchor rods of prior art comprise a bonding section, which is embedded with a curable mass in the prepared bore hole, and a fastening thread, which transfers forces to the underground applied upon the attachment end of the anchor rod projecting from the bore hole. A distortion lock is arranged at the bonding section in order to prevent the anchor rod from being able to be rotated out of the underground during the application of force upon the attachment end in the circumferential direction. A distortion lock of prior art comprises, for example, a section of the bonding section provided with a longitudinal bead. Another distortion lock of prior art provides in the area of the bonding section a trilobed cross section. Here it is disadvantageous that the section in which the distortion lock is embodied cannot contribute to compensate any load.

### BRIEF SUMMARY OF THE INVENTION

An anchor rod for chemical fastening in a bore hole is provided. The anchor rod has a bonding section including a fastening thread, which is provided for embedding in the bore hole. The bonding section includes at least one distortion lock with a clamping structure embodied such that when the bonding section is embedded in the bore hole it develops a clamping effect in the longitudinal direction (A) of the bonding section when a force acts in the circumferential direction upon the fastening thread.

### BRIEF DESCRIPTION OF THE DRAWINGS

In the following, the invention is described in greater detail using several exemplary embodiments with reference to the attached drawings. The drawings show:

FIG. 1: a schematic cross section of an anchor rod according to the invention in a first embodiment, embedded in a bore hole;

FIG. 2: a schematic, perspective view of the anchor rod of FIG. 1; and

FIG. 3: a schematic, perspective view of an anchor rod according to the invention in a second embodiment.

### DETAILED DESCRIPTION OF THE INVENTION

One or more embodiments of the present invention provide an anchor rod with an improved distortion lock. This is attained in an anchor rod for the chemical bonding in a bore hole, provided with a bonding section comprising a fastening thread, intended for the embedding in the bore hole, with the bonding section at least comprising a distortion lock with a clamping element embodied such that, when the bonding section is embedded in the bore hole, a clamping effect is applied at least in the longitudinal direction of the bonding section when a force acts upon the fastening thread in the circumferential direction.

One or more embodiments of the present invention are based on the acknowledgement that during the cooperation of a thread with a clamping element it may be utilized that, in simple terms, the clamping element counteracts a rotary motion of the fastening thread in the cured fastening material surrounding the bonding section by a clamping force in the longitudinal direction being caused in the surrounding material. This axial clamping, which results due to the thread pitch under a load in the circumferential direction of the anchor rod, also prevents a motion of the fastening thread in the circumferential direction. According to this principle, here no distortion lock with a large axial length is required in order to be wedged in the surrounding material, but a clamping element short in the longitudinal direction is sufficient in order to result in a secure fixation of the anchor rod.

Of course, based on the embedding of the bonding section in the surrounding cured mass, under load in the circumferential direction a clamping effect also results in the circumferential direction due to the high friction, even increased by the clamping force acting in the longitudinal direction, between the clamping element and the surrounding material.

The clamping element may be embodied in various fashions.

In one embodiment of the threaded rod, the clamping element shows a cross section approximately equivalent to the section of the bonding section adjacent to the clamping element, seen from the insert end in the longitudinal direction. This way it is achieved that the force, when the threaded rod is driven into the bore hole, is not unnecessarily increased and the curable mass may, unhindered, fill the gap between the wall of the bore hole and the bonding section around the clamping element. In an alternative embodiment the clamping element shows at least sectionally a larger cross section than the area of the bonding section adjacent to the clamping element, seen in the longitudinal direction from the inserting end. This way it is ensured that the clamping element cannot be pulled in the longitudinal direction into the thread. When a force acts in the circumferential direction upon the anchor rod the clamping element jams in the longitudinal direction in the surrounding cured mass, which was filled into the bore hole after the placement of the bonding section, and this way prevents distortion of the fastening thread in the pull-out direction.

In a preferred embodiment the clamping element is embodied as a conical section arranged in the longitudinal direction of the fastening section. The axial length of the conical section may here be approximately equivalent or smaller than the pitch of the fastening thread. It has been shown that a greater axial length is unnecessary. An advantageous embodiment for the conical section is the form of a frustum, with the base area essentially being aligned perpendicular in reference to the longitudinal axis.

The cone area is advantageously facing away from the insert end.

The conical angle may here be approximately the same as the gliding angle of the fastening thread. This way, the clamping element itself may contribute to compensate any load. Additionally, this way the minimal gliding required for transforming axial forces into radial ones is not hindered.

In a preferred embodiment of the invention the clamping element forms the insert end of the anchor rod, thus it is arranged in the inserted state at the lowest point of the anchor rod in the bore hole. Particularly in a clamping element embodied as a conical section the strong forces acting at this point may be introduced under load without problems into the surrounding material.

In another preferred embodiment the clamping element is arranged at the attachment end of the fastening section, thus in the embedded state at the upper end of the bore hole. Here, too, the same advantages and effects develop as described above.

The clamping element may also be provided at another location of the bonding section. It is also possible to provide several clamping elements distributed over the length of the bonding section. The form of the clamping element may show a circular cross section, similar to a conical section, however clamping elements with irregular cross sections are also possible. The clamping element may also comprise a section of the fastening thread with an off-set area or with a different thread pitch.

The smallest exterior diameter of the clamping element may be approximately the same size as the core diameter of the fastening thread. The maximum exterior diameter of the clamping element may also be greater than the maximum exterior diameter of the fastening thread. Preferably the exterior diameter of the clamping element is equivalent to the exterior diameter of the fastening thread. Using such embodiments an easily produced and very stable anchor rod may be created.

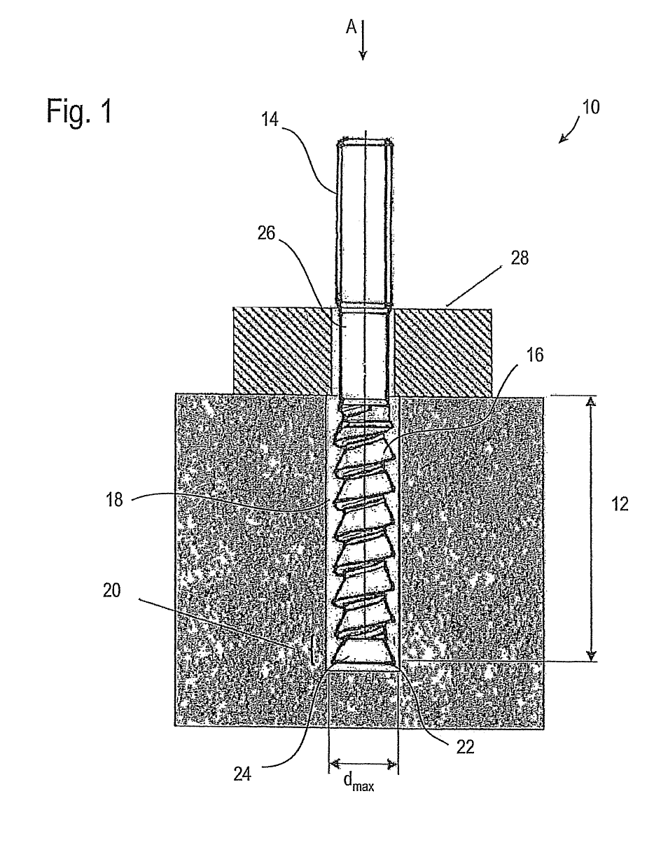

FIG. 1 shows an anchor rod 10, comprising a bonding section 12 as well as an attachment section 14. The bonding section 12 has a fastening thread 16 and is provided, as shown in FIG. 1, to be inserted into a prepared bore hole 18.

After the anchor rod 10 has been inserted the bore hole 18 is filled with a suitable curable mass, for example a cement or an adhesive, with a form-fitting and material-fitting connection of the bonding section 12 developing with said curable mass. Here, the bore hole 18 has a diameter selected of such greater dimension than the maximum diameter of the bonding section 12 is surrounded at all sides with the curable mass.

A distortion lock 20 is embodied at the bonding section 12, namely in this example at the insert end 22, which forms the end of the bonding section 12, which forms in the embedded state the part of the anchor rod 10 most deeply in the bore hole. The distortion lock 20 comprises a clamping element 24, which here is formed in the shape of a conical section arranged in the longitudinal direction A of the bonding section 12. The conical section has the shape of a frustum, with the base area of the frustum essentially being aligned perpendicular in reference to the longitudinal direction A. The conical area here points away from the insert end 22. In the example shown the clamping element 24 directly follows the lowermost winding of the fastening thread 16.

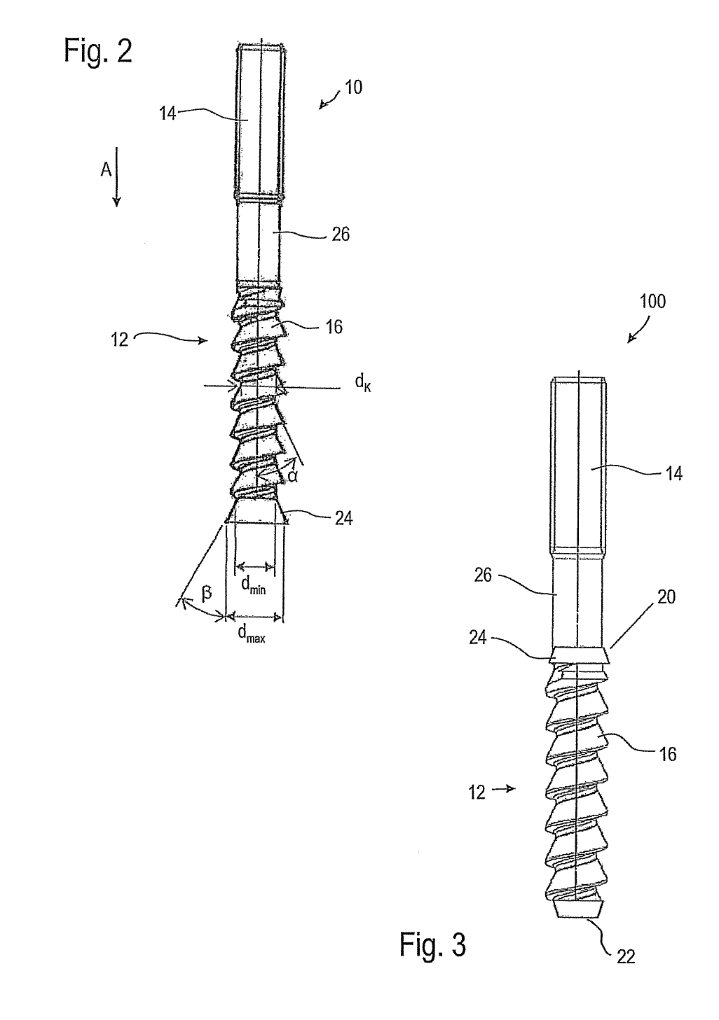

The geometry of the fastening thread 16 and the clamping element 24 is clearly shown in FIG. 2. The maximum exterior diameter dₘₐₓ of the conical section is selected approximately 0.2 mm smaller than the diameter of the bore hole. The smallest interior diameter of the conical section dₘᵢₙ is approximately equivalent to the core diameter d_{K} of the fastening thread 16. The conical angle β of the conical area with the longitudinal direction A is approximately of the same size as the conical angle a of the fastening thread 16 (also measured in reference to the longitudinal direction A). Angular deviations of +/−15° have no hindering influence upon the function, as tests have shown.

The distortion lock 20 acts as follows. When a force acts upon the attachment section 14 in the circumferential direction, for example, through a thread embodied there (not shown, here), in the pull-out direction of the fastening thread 16, the clamping element 24 is stressed in the longitudinal direction A away from the insert end 22 upwards in the direction towards the opening of the bore hole 18. This way, a clamping develops in the longitudinal direction A. The clamping element 24 cannot penetrate the thread channel of the fastening thread 16 because in the present case on the one hand the angle β of the cone is not equivalent to the angle a of the fastening thread 16 and on the other hand the clamping element 24 is wider than the diameter of the fastening thread 16. Due to the clamping in the longitudinal direction A a distortion of the anchor rod 10 per se is also prevented.

FIG. 3 shows a second embodiment of an anchor rod 100. Differently from the above-described embodiment the distortion lock 20 is arranged with a conical clamping element 24 at the upper end of the bonding section 12 in reference to the insert end 22, however, in any case in an area which is embedded in the bore hole 18. The effectiveness is the same as the one described above.

In the examples shown the attachment section 14 is embodied such that a section 26 with a slightly reduced diameter is provided between the free end of the attachment section 14 and the beginning of the bonding section 12, which may be used to fix another attachment part 28 (see FIG. 1) or to apply lettering on the anchor rod. The section 26 may also show the same diameter as the attachment section 14 or, if the attachment section 14 is provided with a thread, also show a thread.

Contrary to anchor rods of prior art, for example, with a bead embodied as the distortion lock, in these examples the pitch of the fastening thread 16 is reduced, while the conical angle a is greater. The maximum diameter of the thread as well as the core diameter d_{K} are approximately equivalent. The pitch is also smaller and the overall length of the thread may be enlarged because the clamping element 24 shows a smaller need for axial space than a bead. The lower pitch has the effect that the extension load that may be applied upon the anchor rod is increased.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. An anchor rod for the chemical fastening in a bore hole, said anchor rod including:
a bonding section comprising a fastening thread provided for the embedding in the bore hole, wherein the bonding section includes at least one distortion lock; and
a clamping element embodied such that it applies a clamping effect at least in the longitudinal direction (A) of the bonding section when the bonding section is embedded in the bore hole and a force acts in the circumferential direction upon the fastening thread.

2. The anchor rod of claim 1 wherein the clamping element shows a cross section equivalent to the section of the bonding section adjacent to the clamping element seen from an insert end in the longitudinal direction (A).

3. The anchor rod of claim 1 wherein the clamping element shows at least sectionally a larger cross section than the area of the bonding section adjacent to the clamping element, seen in the longitudinal direction (A) from the insert end.

4. The anchor rod of claim 1 wherein the clamping element is embodied as a conical section arranged in the longitudinal direction (A) of the bonding section.

5. The anchor rod of claim 2 wherein conical area points away from the insert end.

6. The anchor rod of claim 4 wherein the conical angle (β) is approximately equivalent to the gliding angle (α) of the fastening thread.

7. The anchor rod of claim 1 wherein the clamping element forms the insert end of the anchor rod.

8. The anchor rod of claim 1 wherein the clamping element is arranged at an attachment side end of the bonding section.

9. The anchor rod of claim 1 wherein the maximum exterior diameter (dₘₐₓ) of the clamping element is larger than the maximum exterior diameter of the fastening thread.

10. The anchor rod of claim 1 wherein the smallest exterior diameter (dₘₐₓ) of the clamping element is approximately equivalent to the core diameter (d_{K}) of the fastening thread.
